(19) United States
(12) Patent Application Publication
(10) Pub. No.: US 2005/0224201 A1
(43) Pub. Date: Oct. 13, 2005

(54) Treated crimped multi-ply product

(75) Inventors: Gary Vance Anderson, Larsen, WI (US); Michael John Rekoske, Appleton, WI (US); Lee Patrick Garvey, Kaukauna, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/822,160

(22) Filed: Apr. 8, 2004

(51) Int. Cl. D21H 27/30; B31F 1/07

(52) U.S. Cl. 162/123; 162/127; 162/117; 162/161; 162/158

(57) ABSTRACT

By specifically orientating an interior surface with an applied chemical additive in a multi-ply web with respect to the crimping roll, the ply attachment strength between the plies can be increased. In one aspect, a three-ply facial tissue product has the middle ply treated with a virucidal chemical additive. The three plies are crimped together such that the interior surface with the virucidal chemical additive faces the protuberances of a crimping roll as the plies are crimped together. When crimped in this manner, the variability in the ply attachment strength between the first outer ply and the middle ply as compared to the ply attachment strength between the middle ply and the second outer ply is reduced.

### BACKGROUND

The surfaces of webs are often treated to enhance their usefulness. For instance, the surfaces can be printed, embossed, or have various chemicals, lotions or emollients applied to them amongst other treatment possibilities. Frequently, in a product sold with two or more webs combined together, such as a three-ply facial tissue, it can be desirable to treat the middle ply. For instance, virucidal chemical additives can be a useful treatment to reduce the spread of cold viruses. Virucidal chemical additives can be irritating to noses; especially, when a person's nose may already be irritated due to a cold or the flu. Thus, placing the virucidal treated ply between the outer plies of the three-ply facial tissue can reduce nasal irritation by preventing contact between the person's nose and the virucidal treated ply.

Crimping is a process frequently used to attach individual webs or plies to one another to form a multi-ply product. Crimping involves placing the multi-ply web in the nip between an anvil roll and a crimping roll. The rolls are then loaded together during rotation such that the protuberances on the crimping roll crush or indent the individual plies of the multi-ply web resulting in mechanically induced bonds that hold the webs together similar to spot welding of sheet metal.

Since crimping relies on the formation of bonds between the individual plies to hold the webs together, the presence of chemicals, lotions or virucidal chemical additives on the surfaces of the plies can interfere with the crimping process, reducing or even preventing bonding between the individual plies. This can be especially problematic for a virucidal treated multi-ply web since the treated middle ply could be inadvertently exposed should the bonds fail and the individual plies become separated. Thus, what is needed is a multi-ply product and method that generates improved bond strength even in the presence of chemical additives that have been applied to the surfaces of the individual plies.

### SUMMARY

The inventors have discovered that by carefully orientating the treated ply with the applied chemical additive with respect to the crimping roll, the ply attachment strength between the plies can be increased. In one aspect of the present invention, a three-ply facial tissue product has the middle ply treated with a virucidal chemical additive. Then the three plies are crimped together such that the interior surface with the virucidal chemical additive faces the protuberances of the crimping roll as the plies are crimped together. When crimped in this manner, the variability in the ply attachment strength between the first outer ply and the middle ply as compared to the ply attachment strength between the middle ply and the second outer ply is reduced.

Hence in one aspect, the invention resides in a multi-ply product including at least two plies, each ply having at least one interior surface; a chemical additive applied to at least one of the interior surfaces; a plurality of crimping bond depressions holding the at least two plies together; and wherein the chemical additive is applied to the at least one interior surface such that the chemical additive resides on an upper surface of the crimping bond depression.

In another aspect, the invention resides in a multi-ply tissue product including a first outer ply, a middle ply, and a second outer ply; a chemical additive applied to one interior surface of the middle ply; a plurality of crimping bond depressions holding the three plies together; and wherein the chemical additive resides on an upper surface of the crimping bond depression on the middle ply.

In another aspect, the invention resides in method including combining at least two plies to form a multi-ply web, applying a chemical additive to at least one interior surface of one ply, orienting the interior surface with the applied chemical additive to face a plurality of protuberances on a crimping roll, and crimping the at least two plies together to form a plurality of crimping bond depressions such that the applied chemical additive resides on an upper surface of the crimping bond depressions.

### BRIEF DESCRIPTION OF THE DRAWINGS

The above aspects and other features, aspects, and advantages of the present invention will become better understood with regard to the following description, appended claims, and accompanying drawings in which:

FIG. 1 illustrates a crimping process for a multi-ply web in accordance with the invention.

FIG. 2 illustrates a photomicrograph of a plurality of crimping bonds created by the crimping process of FIG. 1.

FIG. 3 illustrates a cross-section of a crimped three-ply web in accordance with the invention.

Repeated use of reference characters in the specification and drawings is intended to represent the same or analogous features or elements of the invention.

### DEFINITIONS

As used herein, forms of the words “comprise”, “have”, and “include” are legally equivalent and open-ended. Therefore, additional non-recited elements, functions, steps or limitations may be present in addition to the recited elements, functions, steps, or limitations.

As used herein “chemical additive” means any useful chemical or mixture of various chemicals that enhances the functionality of the web or substrate for its intended purpose. Possible chemical additives include, without limitation, strength additives, absorbency additives, softener additives, surfactant additives, conditioning additives, aesthetic additives such as fragrances or dyes. Other additives include, without limitation, anti-acne additives, antimicrobial additives, antifungal additives, antiseptic additives, antioxidants, cosmetic astringents, drug astringents, deodorants, detergents, emollients, external analgesics, binders, film formers, skin moisturizing ingredients as known in the art, opacifiers, skin conditioning agents, skin exfoliating agents, skin protectants, sunscreens, vapor rubs and the like. Suitable chemical additives are disclosed in U.S. Pat. No. 5,400,403 issued to Troken et al. on Nov. 24, 1998 entitled “Multi-Elevational Tissue Paper Containing Selectively Disposed Papermaking Additive” and herein incorporated by reference in a consistent manner.

A useful chemical additive for either enhancing a tissue web's softness or for enhancing the barrier properties of tissue to moisture penetration comprises polysiloxane. Additional information on suitable polysiloxane chemical additives can be found in the following United States patents: U.S. Pat. No. 4,950,545 issued to Walter et al. on Aug. 21, 1990, entitled “Multifunctional Facial Tissue”; U.S. Pat. No. 5,227,242 issued to Walter et al. on Jul. 13, 1993, entitled “Multifunctional Facial Tissue”; U.S. Pat. No. 5,558,873 issued to Funk et al. on Sep. 24, 1996, entitled “Soft Tissue Containing Glycerin and Quaternary Ammonium Compounds”; U.S. Pat. No. 6,054,020 issued to Goulet et al. on Apr. 25, 2000, entitled “Soft Absorbent Tissue Products Having Delayed Moisture Penetration”; U.S. Pat. No. 6,231,719 issued to Garvey et al. on May 15, 2001, entitled “Uncreped Throughdried Tissue with Controlled Coverage Additive”; and U.S. Pat. No. 6,432,270 issued to Liu et al. on Aug. 13, 2002, entitled “Soft Absorbent Tissue”, which are all herein incorporated by reference in a consistent manner.

As used herein a “virucidal chemical additive” means a composition containing a chemical or mixture of chemicals applied to the surface of the web in sufficient concentration to kill viruses such as rhinovirus, parainfluenze virus, or influenza virus. Suitable virucidal chemical additives can include, without limitation, a carboxylic acid or a carboxylic acid in combination with either a nonionic or an anionic surfactant. The anionic surfactant can include, without limitation, sodium lauryl sulfate, LAS, and SAS. The nonionic surfactant can include, without limitation, ethoxylated alcohols, alkanol amides, alkyl polyglucosides, alkylamines, and amine oxides.

Carboxylic acids useful as a virucide can include, without limitation, the compounds having the structure:
R—COOH
wherein R is a radical selected from the group consisting of C₁-C₆ alkyl, substituted C₁-C₆ alkyl, carboxy C₁-C₆ alkyl, carboxyhydroxy C₁-C₆ alkyl, carboxy halo C₁-C₆ alkyl, carboxy dihydroxy C₁-C₆ alkyl, dicarboxyhydroxy C₁-C₆ alkyl, C₁-C₆ alkenyl, carboxy C₁-C₆ alkenyl, dicarboxy C₁-C₆ alkenyl, phenyl, and substituted phenyl radicals. The hydrogen atoms of any of the above compounds may be substituted by one or more functional groups such as halogen atoms, hydroxyl groups, amino groups, thiol groups, nitro groups, and cyano groups, etc.

Acids for use as a virucidal chemical additive can include, without limitation, citric acid, malic acid, maelic acid, tartaric acid, salicylic acid, glycolic acid, adipic acid, glutaric acid, succinic acid, benzoic, and mixtures thereof.

A useful virucidal chemical additive for application to tissue webs comprises 60 percent solids of 2.02 parts Sodium Lauryl Sulfate and 7.35 parts citric acid diluted, and 40 percent water. Additional virucidal chemical additives can include, without limitation, compositions disclosed in the following patents and patent applications all of which are herein incorporated by reference in a consistent manner: U.S. Pat. No. 4,738,847 entitled Multi-Ply Virucidal Product that issued on Apr. 19, 1998 to Rothe et al.; U.S. Pat. No. 4,764,418 entitled Virucidal Tissue Products Containing Water-Soluble Humectants that issued on Aug. 16, 1988 to Kuenn et al.; U.S. Pat. No. 4,897,304 entitled Virucidal Composition, the Method of Use and the Product Therefor that issued Jan. 30, 1990 to Hossain et al.; U.S. Pat. No. 4,828,912 entitled Virucidal Product Having Virucidal and/or Germicidal Properties that issued May 9, 1989 to Hossain et al.; and U.S. patent application Ser. No. 60/174,088 entitled Antimicrobial Absorbent Article and Methods of Making and Using the Same filed on Dec. 30, 1999.

### DETAILED DESCRIPTION

It is to be understood by one of ordinary skill in the art that the present discussion is a description of exemplary embodiments only, and is not intended as limiting the broader aspects of the present invention, which broader aspects are embodied in the exemplary construction.

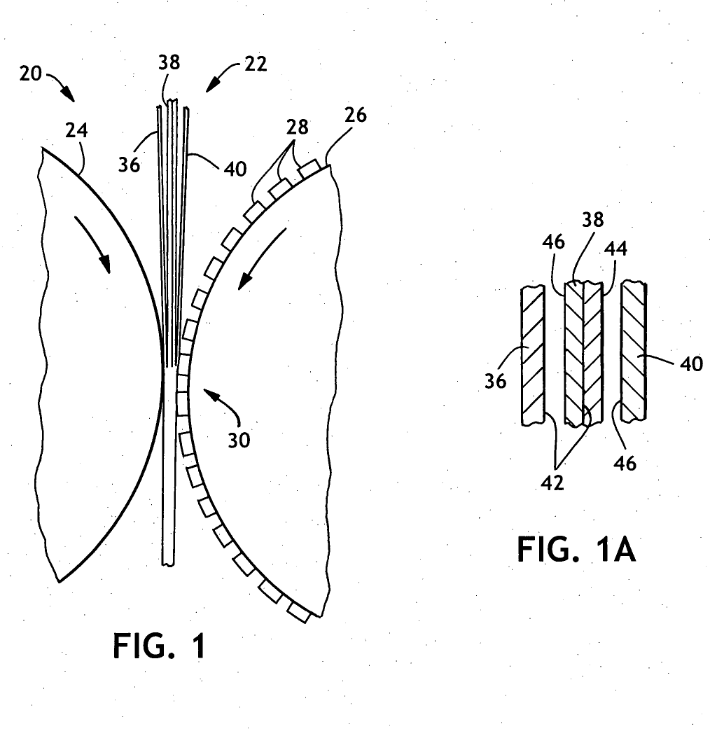

Referring now to FIG. 1, a crimping apparatus 20 for a multi-ply web 22 is illustrated. The crimping apparatus includes an anvil roll 24 and a crimping roll 26 that includes a plurality of protuberances 28. The anvil roll and the crimping roll are loaded together by appropriate means (not shown) to create a nip 30. To crimp the multi-ply web, the multi-ply web is fed into the nip while the anvil roll and crimping roll are rotated as illustrated. The crimped multi-ply web is then removed from the nip for further processing.

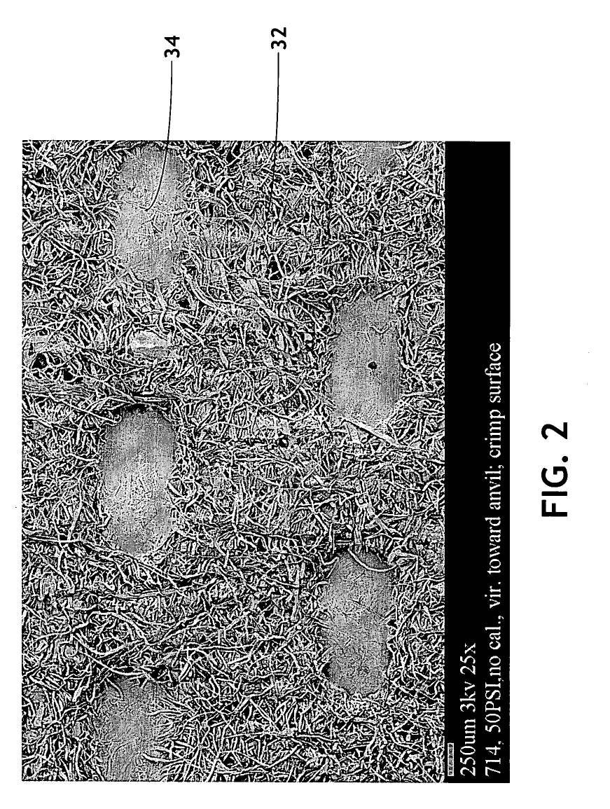

Referring now to FIG. 2, the surface of the multi-ply web after crimping is shown in a photomicrograph. In this particular case, the multi-ply web was a tissue web 32, although the invention is not limited solely to tissue webs. Any suitable multi-ply web material that is capable of being crimp bonded together can be used. As seen, the surface of the tissue web includes a plurality of oval crimping bond depressions 34. The crimping bond depressions hold the plies together of the multi-ply web similar to spot welds in sheet metal. Without wishing to be bound by theory, it is believed that the high load forces induced in the multi-ply web by the protuberances in the nip crush and deform the fibers generating sufficient heat from the pressure to transform the tissue into a glassine material that acts to bond the plies together.

Referring to FIG. 1A, which is an enlargement of the multi-ply web in FIG. 1, the multi-ply web includes a first outer ply 36, a middle ply 38, and a second outer ply 40. The invention is not limited solely to three-ply webs. Instead of the three-ply web illustrated, the multi-ply web can be a two-ply, a four-ply or an N-ply web where N stands for any number of individual plies. Applied to at least one interior surface 42 of at least one of the plies is a chemical additive 44.

The inventors have discovered that the orientation of the treated interior surface with the applied chemical additive 44 is important to achieving optimum ply attachment strength. In particular, the inventors have discovered that the interior surface with the applied chemical additive should face towards the protuberances on the crimping roll to generate improved ply attachment strength. Thus, the interior surface 42 of the first outer ply 36 or the interior surface 42 of the middle ply 38 that face towards the protuberances 28 would be suitable locations for application of the chemical additive 44. On the other hand, interior surfaces 46 of the middle ply 38 and the second outer ply 40 that face away from the protuberances 28 are unsuitable locations for the application of the chemical additive 44 to an interior surface.

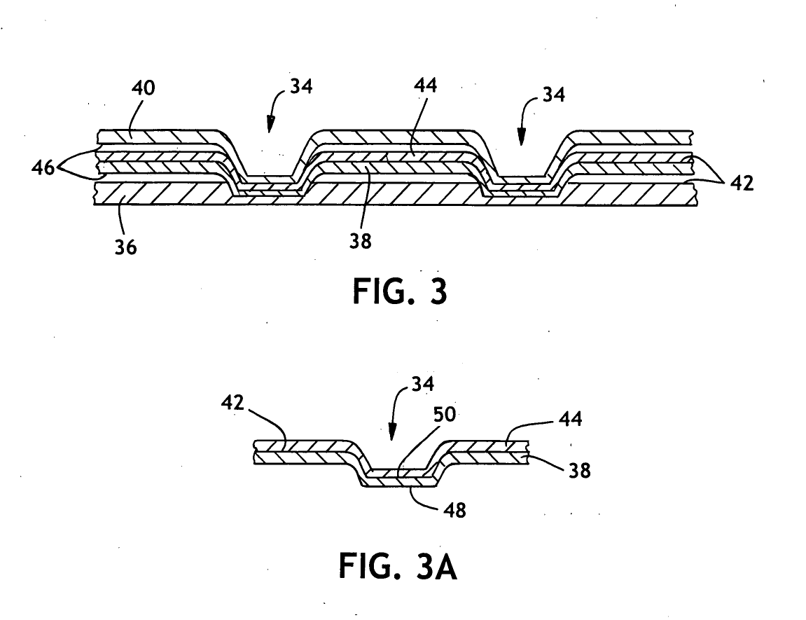

Referring now to FIG. 3, a cross-section of a crimped multi-ply web is illustrated in more detail. The three-plies are crushed together at the plurality of crimping bond depressions 34 after emerging from the crimping apparatus. Referring to FIG. 3A, the middle ply 38 with its applied chemical additive 44 is illustrated for clarity without the two outer plies. Each crimping bond depression 34 has a lower convex side 48 and an upper concave side 50. To generate improved ply attachment strength, the applied chemical additive 44 should reside on the upper concave side 50 of the interior surface 42 at the crimp bond depression. Such a result will automatically occur as long as the treated interior surface with the applied chemical additive faces toward the plurality of protuberances 28 on the crimping roll 26.

The protuberances on the crimping roll can be any size and shape that will bond the multi-ply web together when loaded against the anvil roll. In one embodiment, the protuberances comprised larger ovals with the crimping face having an overall length of approximately 0.05 inch, a width of approximately 0.022 inch, and a height of approximately 0.019 inch. The sidewall of the protuberances was sloped at approximately 12 degrees. The radius of curvature for each end was approximately 0.011 inch. The protuberances were staggered across the face of the approximately 0.250 inch wide crimping roll. Four circumferential lines of protuberances, with the long axis of the ovals parallel to the circumference of the crimping roller, were placed on the crimping roller separated by approximately 0.0625 inches from the centerline of each protuberance. The protuberances were spaced approximately every 0.078 inches within each circumferential line and staggered with an offset of approximately 0.039 inches relative to the adjacent circumferential line of protuberances.

In one embodiment, the protuberances comprised smaller ovals with the crimping face having an overall length of approximately 0.05 inch, a width of approximately 0.016 inch, and a height of approximately 0.019 inch. The sidewall of the protuberances was sloped at approximately 12 degrees. The radius of curvature for each end was approximately 0.008 inch. The protuberances were staggered across the face of the approximately 0.250 inch wide crimping roll. Four circumferential lines of protuberances, with the long axis of the ovals parallel to the circumference of the crimping roller, were placed on the crimping roller separated by approximately 0.0625 inches from the centerline of each protuberance. The protuberances were spaced approximately every 0.084 inches within each circumferential line and staggered with an offset of approximately 0.042 inches relative to the adjacent circumferential line of protuberances.

In another embodiment, the protuberances comprised truncated diamonds with a crimping face measuring approximately 0.025 inch in length on all four edges. At the top and bottom, the edges meet at an approximately 120 degree included angle. At either side, the edges meet at an approximately 60 degree included angle. Axes drawn between opposing corners for each truncated diamond were aligned with either the MD or CD axes of the approximately 0.25 inch wide crimping roller. The base of each truncated diamond was approximately 0.065 inch across opposite top and bottom corners, with a height of approximately 0.015 inch to the crimping face, and a sidewall angle of approximately 52 degrees. The spacing of between each crimping face was approximately 0.040 inch and the spacing between the bases was approximately 0.002 inch when each was measured along an axis rotated approximately 30 degrees to the CD axis.

The materials used to make the crimping roll and the anvil roll can be any suitable material that can withstand the high nip loads. Crimping rolls can be made of CPM-10V steel hardened to a Rockwell C hardness of approximately 60-62. Anvil rolls can be made from 52100 quench and tempered steel, hardened to a Rockwell C hardness of approximately 62-64 for a depth of approximately 0.25 inch.

The loading pressure in the nip in pounds per square inch (psi) for the protuberances against the anvil roll should be sufficient to crush and deform the multi-ply web in order to form the crimping bond depressions. In various embodiments of the invention, the loading pressure can be between about 25,000 psi to about 250,000 psi, between about 50,000 psi to about 200,000 psi, or between about 75,000 psi to about 150,000 psi.

### EXPERIMENTAL RESULTS

A three-ply tissue web was created by plying together three facial tissue plies. Each ply comprised a wet-pressed creped tissue sheet having a basis weight of approximately 24.9 Lbs/2880 sq.ft. and a MD tensile strength of approximately 1300 grams per 3 plies per three inch width. The interior surface of the middle ply was treated with a 9 percent add-on, based on the weight of the three tissue plies, of a virucidal chemical additive comprising 60 percent solids of 2.02 parts Sodium Lauryl Sulfate and 7.35 parts citric acid diluted and 40 percent water. The virucidal chemical additive was applied by flexographic printing of the outer surface of the outer ply. The orientation of the plies was changed by “dropping a ply” to move the virucidal treated outer ply to between the untreated plies as disclosed in U.S. patent application Ser. No. 10/719638 entitled Method for Changing the Orientation of the Plies Within a Multi-Ply Product filed on Nov. 21, 2003 and herein incorporated by reference. When dropping a ply, the orientation of the plies is changed by selecting only a portion of the multi-ply web for threading around the periphery of the roll on the unwind stand, bringing the selected portion into contact with the remaining plies of the multi-ply web, and then threading a converting machine with the reoriented multi-ply web.

After treatment with the virucidal chemical additive and reorientation of the plies within the multi-ply web, the multi-ply web was run through a crimping apparatus having oval protuberances 0.05 inch long by 0.022 inch wide on the crimping roll. For the first run, the interior surface having the virucidal chemical additive was positioned to face away from the crimping roll towards the anvil roll. During the second run, the interior surface having the virucidal chemical additive was positioned to face towards the crimping roll.

The study was done at two different loading pressures of 30 psi and 40 psi applied to the airbags that loaded the crimping rolls against the anvil roll. Using the Hertzian contact equation for parallel isotropic cylinders with a steel anvil roll diameter of 11.9 inches and a steel crimper roll diameter of 6.5 inches, the nip widths at the two loads were calculated taking into account the mechanical advantage of the loading system. The estimated nip width was used to calculate the estimate loading pressure in psi on the protuberances by taking into account the 0.25 inch width of the crimper rolls, the mechanical advantage of the loading system, and the percent contact area for the protuberances as a function of the crimper roll's surface area. For 30 psi of airbag loading pressure, the estimated nip load on the protuberances was 96,200 psi. For 40 psi of airbag loading pressure, the estimated nip load on the protuberances was 110,000 psi.

After crimping the plies together and waiting two weeks before testing, the First-Side Ply Attachment Strength to separate the first outer ply from both the middle ply and the second outer ply was tested according to the Ply Attachment Strength Test. Then the Second-Side Ply Attachment Strength to separate both the first outer ply and the middle ply from the second outer ply was tested. Referring to FIG. 1A, the Ply Attachment Strength Test measured the force to separate ply 36 from plies 38 and 40, and the force to separate plies 36 and 38 from ply 40. Results of the testing are shown in Table 1.

TABLE 1

| | 30 psi Loading Pressure | | 40 psi Loading Pressure | |
|---|---|---|---|---|
| | Treated Interior | Treated Interior | Treated Interior | Treated Interior |
| | Surface Facing | Surface Facing | Surface Facing | Surface Facing |
| | Protuberances | Anvil Roll | Protuberances | Anvil Roll |
| First-Side Ply | 33.5 | 16.7 | 57.7 | 38.9 |
| Attachment Strength | | | | |
| (grams) | | | | |
| Second-Side Ply | 33.7 | 28.1 | 53.6 | 51.1 |
| Attachment Strength | | | | |
| (grams) | | | | |
| Strength Ratio of | 0.99 | 0.59 | 1.08 | 0.76 |
| the First-Side to | | | | |
| the Second-Side | | | | |

As seen in Table 1, the difference in the ply attachment strengths for the First-Side as compared the Second-Side were greatly reduced when the treated surface faced the protuberances of the crimping roll. As a result, the Strength Ratio of the First-Side to the Second-Side was near 1.0, which would mean there was no difference in the ply separation strength for removing each outer ply from the middle ply even in the presence of the applied chemical additive. When the treated interior ply faced away from the protuberances, the side to side variation in the ply strength was much greater and the Strength Ratio did not approach 1.0.

In various embodiments of the invention, the Strength Ratio of the First-Side to the Second-Side can be between about 0.8 to about 1.2 (approximately twenty percent variation), between about 0.85 to about 1.15 (approximately 15 percent variation), between about 0.9 to about 1.1 (approximately ten percent variation), or between about 0.95 to about 1.05 (approximately 5 percent variation).

In various embodiments of the invention, the Ply Attachment Strength, for removing the ply with the treated interior surface from another ply in the multi-ply web can be about 30 grams or greater, about 40 grams or greater, about 50 grams or greater, about 60 grams or greater, between about 30 grams to about 100 grams, or between about 30 grams to about 70 grams, or between about 30 grams to about 60 grams.

In the multi-ply web, it can be advantageous to ensure that the ply attachment strength for each ply is above a minimum threshold in order to hold the plies together during use. It can also be advantageous that the variation in the ply attachment strength between any two plies is minimized such that all plies have approximately the same ply attachment strength.

### TEST METHODS

Ply Attachment Strength Test

This test is used to determine the ply attachment strength by measuring the force in grams required to pull apart individual plies at the crimp lines in a multi-ply product. The test clamps one side of the specimen on a lower moving platen and clamps the ply to be separated during the test in a load cell. The specimen is pulled apart in a 180 degree peel by moving the platen to the left while the force required when pulling the crimping bonds apart is measured by the load cell.

The following materials are required: Slip/Peel Tester, IMASS SP-2000 with a MB-5 five pound force transducer available from Instrumentors, Inc. having an office at 22077 Drake Rd. Strongsville, Ohio 44149 and marketed by Imass, Inc. having an office at Box 134, Accord, Mass. 02018. A platen clamp having the capability to secure the test specimen to the moving platen without slippage. A specimen clamp having the capability to secure the test specimen to the load cell without slippage. The platen clamp and the specimen clamp should be at least as long as the test specimen to ensure the specimen does not rip during testing.

The platen clamp can be constructed from a plastic bar approximately 1 inch in width having two holes and secured to the moving platen by two thumb screws. The specimen clamp can be constructed by cutting a C-Thru Ruler Company ruler, part number W30 or equivalent, into two pieces at least four inches in length. Apply Tesa Tape, Inc. anti-slip tape, part number 4563, or equivalent, to one side of each ruler section. Place the two ruler pieces with the anti-slip surfaces on a table facing down, align the two ruler sections and butt the long edges together. Apply filament tape, 3M part number 898, or equivalent, to the seam between the two ruler pieces to form a living hinge by extending the tape approximately one-half an inch over each ruler piece. Remove the ruler sections from the table and fold in half along the tape seam such that the anti-slip surfaces face each other.

The test specimens are prepared as follows: Cut the multi-ply web into a square 4±0.25 inches by 4±0.25 inches (100±6 mm). The crimping line should be parallel to one edge of the test specimen having a narrow amount of material to one side of the crimping line and a wider section of material to the other side of the crimping line. For facial tissue multi-ply webs avoid the ends of the sample and cut a four inch wide CD strip from the middle of the sheet and then cut four inches in from each MD edge of the sheet to form the test rectangular test specimens.

The test specimens are tested as follows: Conduct the testing in an atmosphere of 23°±1° C. and 50±2% relative humidity. Condition all specimens a minimum of 24 hours prior to testing. Turn on the Slip/Peel tester and wait 15 minutes. At the MAIN SCREEN press OK and at the LOAD CELL LIMIT screen press OK. Insert the specimen clamp into the load cell clamp and calibrate and balance the load cell by pressing the BAL(&CAL) button. Press and hold the RETN button until the platen stops moving. At the TEST CONDITIONS screen verify that the screen shows the following:

| | |
|---|---|
| PEEL | 2 Kg cell |
| force g | .1 sec dly |
| 2.43 in | 5 sec avg |
| time | 28.0 in/min |

Press OK. At the READY TO TEST screen, the return position 0.00 in. is displayed. If necessary, perform the four-point verification before simultaneously pressing and holding the JOG and TEST buttons to move the platen approximately 2.5 inches to the left. Use the MANUAL POSITIONING knob to move the platen until the display reads exactly 2.50 inches. Remove the specimen clip from the load cell clamp. Separate the plies of the test specimen opposite the crimp line without placing any strain on the crimp line. For a three-ply specimen, ten (10) samples should be prepared by separating ply 36 from plies 38 and 40. See FIG. 1A. Ten (10) additional specimens should be prepared by separating ply 40 from plies 38 and 36. Place the single outer ply in the specimen clip and attach the remaining plies of the specimen to the moving platen with the platen clamp. Ensure that the specimen is placed squarely into the Slip/Peel tester with the crimp line is perpendicular to the front edge of the moving platen. Use the MANUAL POSITIONING knob to move the platen to the right or left to eliminate excessive slack or preload after the specimen has been clamped in place. Press TEST and the platen will stop after 5.1 seconds. Read and record the kinetic peak (KP) to the nearest 0.1 gram. Remove the test specimen and press the RETN button. Insert a new test specimen and repeat the testing sequence.

Results are calculated as follows: For a two-ply web or multi-ply web, test at least ten (10) specimens and average the results to obtain the Ply Attachment Strength for separating each ply from any other ply in the multi-ply web. For a three-ply web, test at least ten (10) specimens by measuring the force it takes to remove ply 36 from plies 38 and 40. Average the results to obtain the First-Side Ply Attachment Strength. Then test at least ten (10) specimens by measuring the force it takes to remove ply 40 from plies 38 and 36. Average the results to obtain the Second-Side Ply Attachment Strength. Divide the First-Side Ply Attachment Strength by the Second-Side Ply Attachment Strength to obtain the Strength Ratio of the First-Side to the Second-Side. If there is no variation in crimp bond strength from one side to the other side, the Strength Ratio of the First-Side to the Second-Side will have a value of 1.0.

Other modifications and variations to the present invention may be practiced by those of ordinary skill in the art, without departing from the spirit and scope of the present invention, which is more particularly set forth in the appended claims. It is understood that aspects of the various embodiments may be interchanged in whole or part. All cited references, patents, or patent applications in the above application for letters patent are herein incorporated by reference in a consistent manner. In the event of inconsistencies or contradictions between the incorporated references and this application, the information present in this application shall prevail. The preceding description, given by way of example in order to enable one of ordinary skill in the art to practice the claimed invention, is not to be construed as limiting the scope of the invention, which is defined by the claims and all equivalents thereto.

1. A multi-ply product comprising:
at least two plies, each ply having at least one interior surface;
a chemical additive applied to at least one of the interior surfaces;
a plurality of crimping bond depressions holding the at least two plies together; and
wherein the chemical additive is applied to the at least one interior surface such that the chemical additive resides on an upper concave side of the crimping bond depression.

2. A multi-ply tissue product comprising:
a first outer ply, a middle ply, a second outer ply, and each ply having at least one interior surface;
a chemical additive applied to one interior surface of the middle ply;
a plurality of crimping bond depressions holding the three plies together; and
wherein the chemical additive resides on an upper concave side of the crimping bond depression on the middle ply.

3. The product of claim 1 or 2 wherein the chemical additive comprises a virucidal chemical additive.

4. The product of claim 3 wherein the virucidal chemical additive comprises sodium lauryl sulfate and citric acid.

5. The product of claim 1 or 2 wherein the chemical additive comprises polysiloxane.

6. The product of claim 1 wherein the plies comprise tissue paper.

7. The product of claim 1 or 2 wherein the crimping bond depressions comprise an oval shape.

8. The product of claim 1 or 2 wherein the crimping bond depressions comprise a diamond shape.

9. The product of claim 2 or 3 wherein a Strength Ratio of the First-Side to the Second-Side is between about 0.8 to about 1.2.

10. The product of claim 9 wherein the Strength Ratio is between about 0.9 to about 1.1.

11. The product of claim 1 wherein a Ply Attachment Strength for separating the at least one interior surface with the applied chemical additive from another ply is about 30 grams or greater.

12. The product of claim 1 wherein a Ply Attachment Strength for separating the at least one interior surface with the applied chemical additive from another ply is about 40 grams or greater.

13. The product of claim 1 wherein a Ply Attachment Strength for separating the at least one interior surface with the applied chemical additive from another ply is between about 30 grams to about 100 grams.

14. The product of claim 1 wherein a Ply Attachment Strength for separating the at least one interior surface with the applied chemical additive from another ply is between about 30 grams to about 70 grams.

15. A method comprising:
combining at least two plies to form a multi-ply web, each ply having at least one interior surface;
applying a chemical additive to at least one interior surface of one ply;
orienting the interior surface with the applied chemical additive to face a plurality of protuberances on a crimping roll; and
crimping the at least two plies together to form a plurality of crimping bond depressions wherein that the applied chemical additive resides on an upper surface of the crimping bond depressions.

16. The method of claim 15 wherein the multi-ply includes a first outer ply, a middle ply and a second outer ply.

17. The method of claim 16 wherein the chemical additive is applied to the middle ply.

18. The method of claim 17 wherein the chemical additive is a virucidal chemical additive.

19. The method of claim 15 further comprising a step of dropping a ply to reorient the applied chemical additive to an interior surface prior to crimping the multi-ply web.
